(19) United States
(12) Patent Application Publication
(10) Pub. No.: US 2026/0233636 A1
(43) Pub. Date: Aug. 13, 2026

(54) OUTPUT CONTROL DEVICE

(71) Applicant: Isuzu Motors Limited, Yokohama-shi (JP)

(72) Inventors: Takanobu OGAWA, Fujisawa-shi (JP); Takatada USAMI, Fujisawa-shi (JP); Daichi MAEGAWA, Fujisawa-shi (JP)

(73) Assignee: Isuzu Motors Limited, Yokohama-shi (JP)

(21) Appl. No.: 19/359,752

(22) Filed: Oct. 16, 2025

(30) Foreign Application Priority Data
Oct. 18, 2024 (JP) 2024-182613

(51) Int. Cl. B60L 58/40; B60L 50/75; B60L 58/16; B60L 58/30

(52) U.S. Cl. CPC B60L 58/40; B60L 50/75; B60L 58/16; B60L 58/30

(57) ABSTRACT

An output control device can balance deterioration between battery and fuel cell. The output control device includes an acquisition section acquiring information relating to states of health of the fuel cell and battery outputting power operating a motor as a vehicle driving source, and information indicating a request output from the motor; and a control section controlling the battery and fuel cell so that, when the information on the state of health of the battery is no less than a target value set in advance, the fuel cell outputs predetermined first power regardless of the request output and the battery outputs second power according to the request output, and when the information on the state of health of the battery is larger than the target value, the battery outputs predetermined third power regardless of the request output and the fuel cell outputs fourth power according to the request output.

### CROSS REFERENCE TO RELATED APPLICATIONS

This application claims the benefit of priority of Japanese Patent Application No. 2024-182613 filed on Oct. 18, 2024, the contents of which are incorporated by reference as if fully set forth herein in their entirety.

### Technical Field

The present disclosure relates to an output control device.

### Background Art

A vehicle including a fuel cell stack (FCS) which generates power using hydrogen and a battery (BAT), and driving a motor (electric machine) as a driving source by using the power output by the FCS and the battery to travel is known. In the following description, such a vehicle may be referred to as a fuel cell vehicle (FCV).

In such a vehicle, power is output from the battery and the FCS in response to a request output from the motor. The battery deteriorates according to a usage situation, and a chargeable and dischargeable power amount (capacity) is reduced. On the other hand, the FCS exhibits deterioration as a reduction in a generatable power amount (voltage). When deterioration of at least one of the battery and the FCS has progressed to a certain extent, it is necessary to stop an operation of the vehicle and to replace the deteriorated battery or FCS.

For example, PTL 1 discloses a fuel cell system that changes the flow rate of fuel supplied to the FCS so that the voltage of the FCS increases or decreases across the target voltage while suppressing the current of the FCS to a target current and within a range in which the charge/discharge power of the battery does not exceed the allowable charge power.

### CITATION LIST

### Patent Literature

PTL 1

### Japanese Patent Application Laid-Open No. 2021-190305

### SUMMARY OF INVENTION

### Technical Problem

The larger the amplitude of output fluctuations of an FCS is and the shorter the period is, the more it deteriorates and the more its output is reduced. The state of health (SOH) of an FCS means the rate at which the FCS's output is reduced. In addition, the more a battery is charged and discharged, the more it deteriorates and its capacity is reduced. The state of health (SOH) of the battery means the rate at which its capacity is reduced.

In the fuel cell system disclosed in PTL 1, since the SOHs of the FCS and the battery are separately monitored and the deterioration of the FCS and the battery is suppressed independently. This makes it difficult to balance the deterioration between the FCS and the battery, and there is a concern that a difference in the number of repairs or replacements between the FCS and the battery may occur.

As a result, in the fuel cell system disclosed in PTL 1, for example, it is difficult to maintain durability required for a commercial vehicle over a long period.

An object of the present disclosure is to provide an output control device capable of balancing the degradation between a battery and a fuel cell.

### Solution to Problem

To achieve the above object, an output control device includes the following:
an acquisition section that acquires information relating to a state of health of a fuel cell, information relating to a state of health of a battery, and information indicating a request output from a motor serving as a driving source of a vehicle, the fuel cell being configured to output power for operating the motor, the battery being configured to output power for operating the motor; and
a control section that controls the battery and the fuel cell in such a way that, when the information relating to the state of health of the battery is equal to or less than a target value set in advance, the fuel cell outputs predetermined first power regardless of the request output and the battery outputs second power in accordance with the request output, and when the information relating to the state of health of the battery is larger than the target value, the battery outputs predetermined third power regardless of the request output and the fuel cell outputs fourth power in accordance with the request output.

### Advantageous Effects of Invention

According to the present disclosure, it is possible to balance the deterioration between a battery and a fuel cell.

### BRIEF DESCRIPTION OF DRAWINGS

FIG. 1 schematically illustrates a fuel cell vehicle equipped with an output control device according to an embodiment of the present disclosure;

FIG. 2 is a table indicating the relationship between cruising distance and SOH and the relationship between cruising distance and change rate;

FIG. 3 is a graph indicating the relationship between cruising distance and SOH and the relationship between cruising distance and change rate;

FIG. 4 is a block diagram illustrating a function of a control section;

FIG. 5A illustrates an example of a control method for each of an FCS and a battery in the present embodiment;

FIG. 5B illustrates another example of the control method for each of the FCS and the battery in the present embodiment;

FIG. 6 is a flowchart illustrating an example of an operation of the control section according to the embodiment of the present disclosure;

FIG. 7A illustrates an example of a control method for each of an FCS and a battery in Variation 1;

FIG. 7B illustrates another example of the control method for each of the FCS and the battery in Variation 1;

FIG. 7C illustrates another example of the control method for each of the FCS and the battery in Variation 1;

FIG. 8 is a flowchart illustrating an example of an operation of a control section in Variation 1;

FIG. 9A illustrates an example of a control method for each of an FCS and a battery in Variation 2;

FIG. 9B illustrates another example of the control method for each of the FCS and the battery in Variation 2;

FIG. 9C illustrates another example of the control method for each of the FCS and the battery in Variation 2; and

FIG. 10 is a flowchart illustrating an example of an operation of a control section in Variation 2.

### DESCRIPTION OF EMBODIMENTS

Hereinafter, an embodiment of the present disclosure will be described with reference to the drawings.

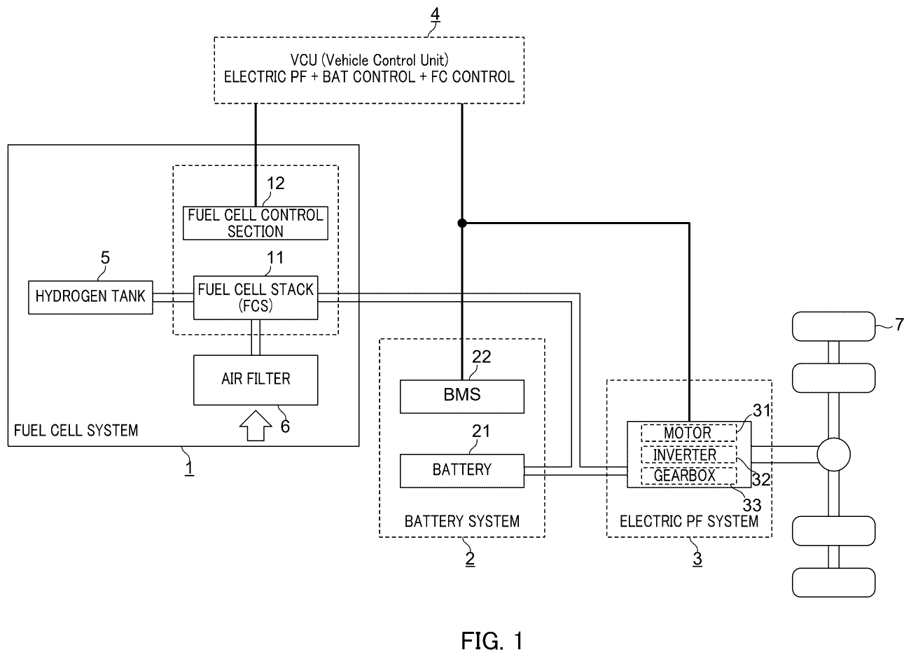

FIG. 1 schematically illustrates a fuel cell vehicle equipped with an output control device according to an embodiment of the present disclosure.

As illustrated in FIG. 1, a fuel cell vehicle (FCV) includes fuel cell system 1, battery system 2, electric platform system 3 (electric PF system), and control system 4 (corresponding to an “output control device” according to the present disclosure).

Fuel cell system 1 includes fuel cell stack 11 (FCS) and fuel cell control section 12 (fuel cell stack electronic control unit: FCS ECU). Hydrogen is supplied to FCS 11 from hydrogen tank 5. In addition, oxygen is supplied to FCS 11 via air filter 6. Fuel control section 12 controls the pressure and the amount of each of hydrogen and oxygen supplied to FCS 11. FCS 11 supplies electricity generated in a process of converting hydrogen and oxygen into water to motor 31. Fuel cell control section 12 estimates the current SOH of FCS 11 and transmits the estimated SOH to control system 4.

Battery system 2 includes battery 21 and battery management system (BMS) 22. Battery 21 is configured by combining a plurality of cells and outputs power for operating motor 31. BMS 22 is an electronic control circuit that monitors and controls charging and discharging of battery 21. For example, BMS 22 measures the voltage, the current, and the temperature of a cell, and performs disconnection control of a power output terminal when the voltage, the current, and the temperature of the cell exceed specified ranges. This configuration prevents overcharging, overdischarging, overcurrent, and the like of battery 21. In addition, BMS 22 estimates a remaining capacity (state of charge: SOC) of battery 21. BMS 22 estimates the current SOH of battery 21 and transmits the estimated SOH to control system 4.

Electric PF system 3 includes motor 31, inverter 32, and gearbox 33. Motor 31 is a motor for driving the vehicle. The rotation speed of motor 31 is controlled by control system 4 to output a required torque in response to a request (accelerator pedal opening) from a driver. Inverter 32 converts direct current (DC) supplied from each of FCS 11 and battery 21 to motor 31 into alternating current (AC). Gearbox 33 reduces the rotation speed of motor 31 so that motor 31 outputs a required torque. The output torque is transmitted to wheels 7 of the FCV.

In a fuel cell vehicle (FCV), which includes FCS 11 and battery 21 and drives motor 31 using the power output by each of FCS 11 and battery 21 to travel, the following problem occur: when the SOH (state of health) of FCS 11 and the SOH of battery 21 are separately monitored and the deterioration is suppressed independently in the FCS and the battery, it becomes difficult to balance the deterioration between FCS 11 and battery 21. As a result, there is a concern that a difference in the number of repairs or replacements between FCS 11 and battery 21 may occur.

Control system 4 is a vehicle control unit (VCU) that performs control of each of fuel cell system 1, battery system 2, and electric PF system 3. Specifically, control system 4 controls a charging and discharging amount of battery 21 based on the relationship between the request output from motor 31 and the output from FCS 11. In addition, control system 4 controls the absorbed power during regenerative braking according to the SOC of battery 21. Control system 4 also controls the amount of power generated by FCS 11 in response to the request output from motor 31. In addition, control system 4 controls on/off of FCS 11 according to an environmental condition, a preparation situation, or a traveling state of the vehicle.

In the present embodiment, a degree of reduction of the SOH of each of FCS 11 and battery 21 is converted into a change rate (corresponding to “information relating to the state of health” according to the present disclosure) of 0% to 100%.

Fuel cell control section 12 estimates (calculates) the current SOH of FCS 11. A known method such as modeling (simulation), a constant current/constant voltage test, or an internal resistance measurement method is used for estimating the SOH of FCS 11. In the modeling (simulation), a mathematical model that reproduces a deterioration mechanism is created, and a progression status of the SOH is estimated in fuel cell control section 12. In the constant current/constant voltage test, FCS 11 is charged and discharged at a constant current or is operated at a constant voltage, and the SOH is estimated from the response. In the internal resistance measurement method, an internal resistance of FCS 11 is monitored, and the SOH is estimated from the amount of change.

The SOH of FCS 11 refers to a proportion of output P (W) of FCS 11 at the current time when output P (W) at a start of use of FCS 11 is set to 100%. In addition, the change rate of the SOH of FCS 11 refers to the proportion of the amount of change in the SOH from the start of use of FCS 11 to the current time with respect to the total amount of change in the SOH from the start of use of FCS 11 to the end of life at which the use of FCS 11 reaches an end due to its lifetime.

BMS 22 estimates (calculates) the current SOH of battery 21. A known method such as an OCV test, a method using data of BMS 22, or an impedance or internal resistance test is used for estimating the SOH of battery 21. In the OCV test, a voltage is measured in a stable state of battery 21, and the SOH is estimated from the relationship of ΔSOC (SOC increase amount)/ΔAh (current increase amount). In the method using data of BMS 22, the SOH is estimated from, for example, the charging and discharging cycle, the maximum/minimum voltage, the temperature history, or the like of battery 21. In the impedance or internal resistance test, impedance or resistance is read, and the SOH is estimated from the amount of change.

The SOH of battery 21 refers to a proportion of a fully charged capacity of battery 21 at the current time when a fully charged capacity of battery 21 at a start of use is set to 100%. In addition, the change rate of the SOH of battery 21 refers to a proportion of the amount of change in the SOH from the start of use of battery 21 to the current time with respect to the total amount of change in the SOH from the start of use of battery 21 to the end of life at which the use of battery 21 reaches an end due to its lifetime. As a result, it is possible to relatively monitor the degrees of reduction of the SOH of respective FCS 11 and battery 21 based on the change rate of the SOH of each of FCS 11 and battery 21.

On the basis of the change rate of the SOH of each of FCS 11 and battery 21, control system 4 controls the amount of power to be supplied from FCS 11 to motor 31 and the amount power to be supplied from battery 21 to motor 31 so that the deterioration of FCS 11 and battery 21 is balanced. In the following description, FCS 11 and battery 21 are collectively referred to as a “power source”. In addition, the SOH (state of health) of a power source may be simply referred to as “SOH” or “state of health”. In addition, the change rate of the SOH of a power source may be simply referred to as a “change rate”.

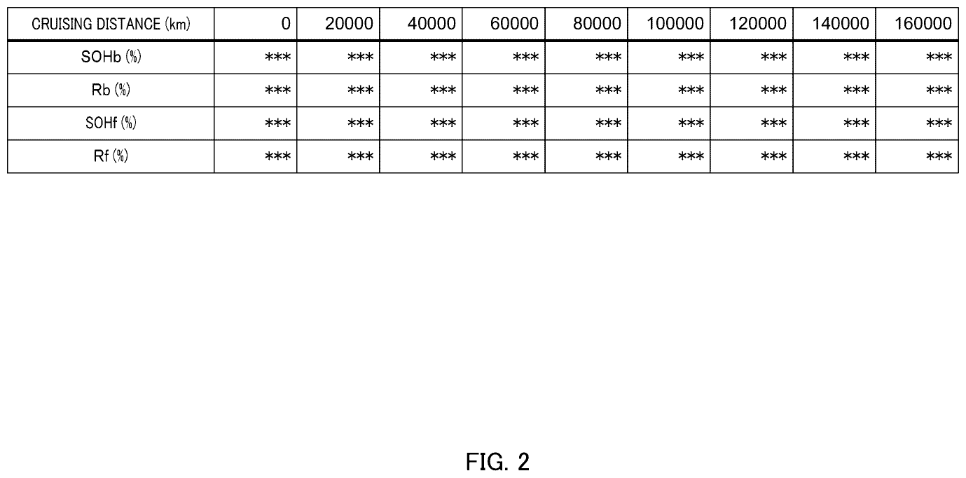

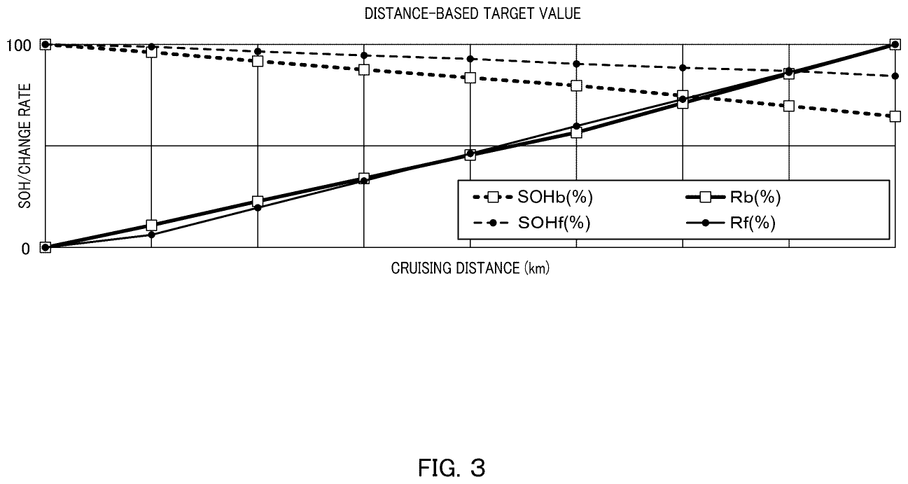

Next, an example of the SOH and the change rate will be described with reference to FIGS. 2 and 3. FIG. 2 is a table indicating the relationship between cruising distance (km) and SOH (%) and the relationship between cruising distance (km) and change rate (%). In FIG. 2, redacted characters are indicated by “***”. FIG. 3 is a graph indicating the relationship between cruising distance (km) and SOH (%) and the relationship between cruising distance (km) and change rate (%). In FIG. 3, the horizontal axis indicates cruising distance (km), and the vertical axis indicates SOH and change rate (%). In FIGS. 2 and 3, the state of health of FCS 11 is indicated by “SOHf”, and the change rate of the state of health of FCS 11 is indicated by “Rf”. In addition, the state of health of battery 21 is indicated by “SOHb”, and the change rate of the state of health of battery 21 is indicated by “Rb”. In FIG. 3, the SOHf is represented by a thin broken line, and the Rf is represented by a thin solid line. In addition, in FIG. 3, the SOHb is represented by a thick broken line, and the Rb is represented by a thick solid line.

As illustrated in FIGS. 2 and 3, the SOHf decreases according to the cruising distance of the vehicle. In addition, the Rf increases according to the cruising distance. In general, the SOHf at the start of use of FCS 11 is 100 (%).

When the SOHf at the start of use of FCS 11 is denoted by SOHfa, the SOHf at the end of life of FCS 11 is denoted by SOHfb, and the SOHf at the current time is denoted by SOHfc, the Rf can be calculated by Equation (1).

$$Rf = ( SOHfa - SOHfc ) / ( SOHfa - SOHfb ) * 100 \qquad Equation ( 1 )$$

Therefore, the Rf at the start of use of FCS 11 is 0 (%) (=0/100), and the Rf at the end of life of FCS 11 is 100 (%) (=100/100).

As illustrated in FIGS. 2 and 3, the SOHb decreases according to the cruising distance of the vehicle. In addition, the Rb increases according to the cruising distance. In general, the SOHb at the start of use of battery 21 is 100 (%).

When the SOHb at the start of use of battery 21 is denoted by SOHba, the SOHb at the end of life battery 21 is denoted by SOHbb, and the SOHb at the current time is denoted by SOHbc, the Rb can be calculated by Equation (2).

$$Rb = ( SOHba - SOHbc ) / ( SOHba - SOHbb ) * 100 \qquad Equation ( 2 )$$

Therefore, the Rb at the start of use of battery 21 is 0 (%) (=0/100), and the Rb at the end of life of battery 21 is 100 (%) (=100/100).

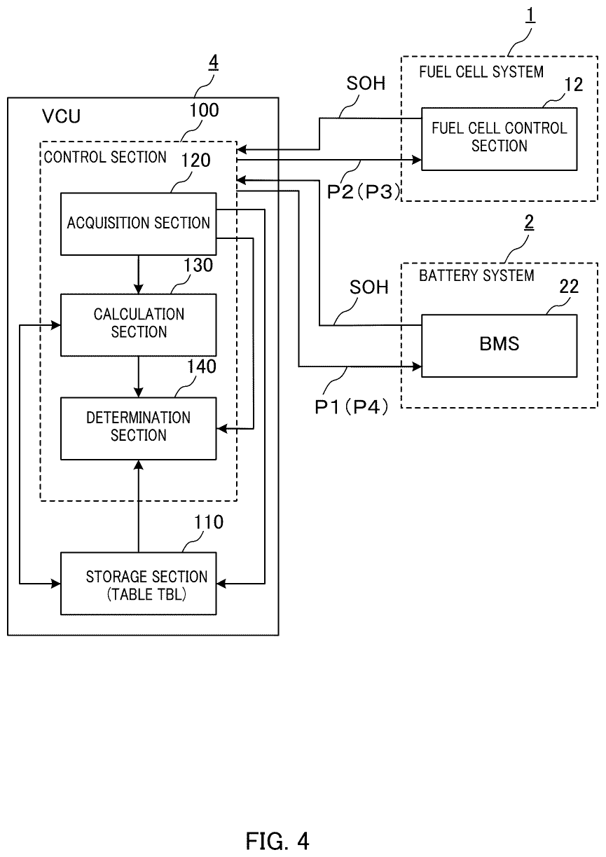

Control system 4 includes control section 100 and storage section 110 (see FIG. 4). Storage section 110 is a read only memory (ROM) that stores a program of a computer for implementing control system 4, or a random access memory (RAM) that that serves as a work area for control section 100. Control system 4 also includes an interface such as an A/D converter, a D/A converter, an I/O port, and/or CAN as an interface. The ROM may be a storage device such as a hard disk drive (HDD) or a solid state drive (SSD) that stores an operating system (OS), application programs, or various types of information referenced when the application programs are executed.

Control section 100 is a processor such as a central processing unit (CPU) or a graphics processing unit (GPU) of control system 4, and functions as described below by executing a program stored in storage section 110. Control section 100 is not limited to a case of being configured as a single device. Control section 100 may be realized by, for example, a plurality of processors or a calculation resource such as a memory. In this case, each unit constituting control section 100 is realized by at least one processor of the plurality of different processors executing a program.

Storage section 110 stores the cruising distance (km). In addition, storage section 110 stores in advance the SOHfa at the start of use of FCS 11 and the SOHfb at the end of life of FCS 11. Storage section 110 also stores in advance the SOHba at the start of use of battery 21 and the SOHbb at the end of life of battery 21.

FIG. 4 is a block diagram illustrating a function of control section 100. Control section 100 functions as acquisition section 120, calculation section 130, and determination section 140.

Acquisition section 120 acquires the SOHf of FCS 11 from fuel cell control section 12. Acquisition section 120 also acquires the SOHb of battery 21 from BMS 22.

Acquisition section 120 acquires request output (W) from motor 31.

Calculation section 130 calculates the Rf with reference to Equation (1) based on the SOHfa at the start of use of FCS 11 and the SOHfb at the end of life of FCS 11 read out from storage section 110, and the acquired SOHfc at the current time.

Calculation section 130 calculates the Rb with reference to Equation (2) based on the SOHba at the start of use of battery 21 and the SOHbb at the end of life of battery 21 read out from storage section 110, and the acquired SOHbc at the current time.

Determination section 140 determines whether the Rb is equal to or less than a predetermined target value. In the present embodiment, the target value is set to Rf. The target value may be referred to as a “threshold value”. Therefore, determination section 140 determines whether the Rb is equal to or less than the Rf.

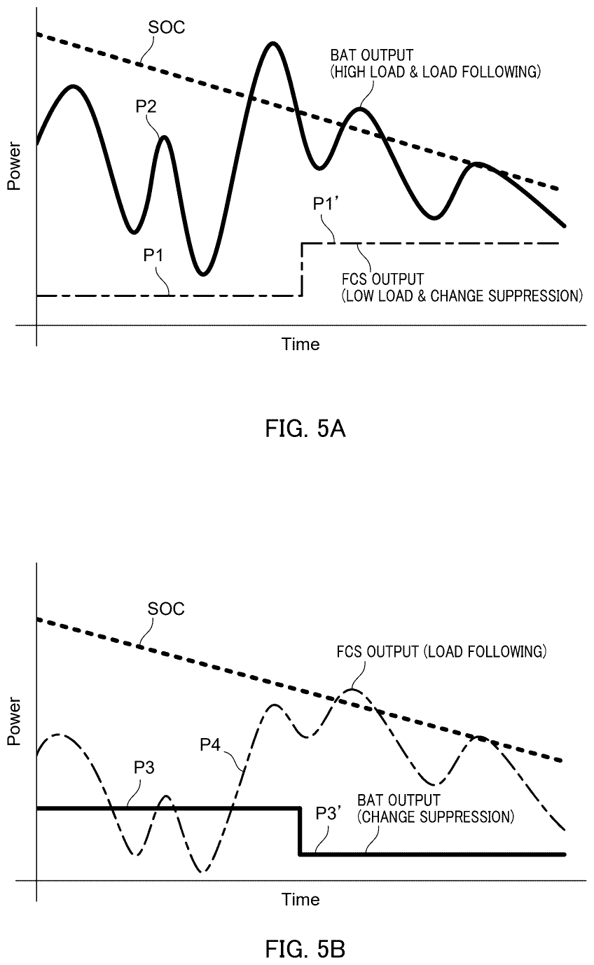

FIG. 5A illustrates an example of a control method for (that is, a method for controlling) each of the FCS and the battery in the present embodiment. FIG. 5B illustrates another example of the control method for each of the FCS and the battery in the present embodiment. In each of FIG. 5A and FIG. 5B, the horizontal axis indicates Time (time), and the vertical axis indicates Power (output). In addition, FIG. 5A and FIG. 5B illustrate an SOC that decreases with the elapse of time.

When the Rb is equal to or less than the Rf, control section 100 controls FCS 11 and battery 21 in such a way that FCS 11 outputs predetermined first power P1 (W) regardless of the request output (W) and battery 21 outputs second power P2 (W) in accordance with the request output. When the Rb is equal to or less than the Rf, as illustrated in FIG. 5A, FCS 11 outputs first power P1, which is predetermined power lower than power in accordance with the request output. First power P1 of FCS 11 may increase as the SOC of battery 21 decreases. On the other hand, battery 21 outputs second power P2, which is a difference between the request output and first power P1. As a result, the deterioration of FCS 11 having a larger change rate is suppressed (FCS deterioration suppression).

In the FCS deterioration suppression, it is desirable to control the output of FCS 11 in a region where the power generation efficiency is at a certain level or more. The reason for this is that, when FCS 11 is used in a region where the power generation efficiency is high, FCS 11 generates less heat, so that deterioration due to heat can be suppressed, and also because FCS 11 has a characteristic such that the power generation efficiency is maximized on the low output side. As a result, first power P1 described above is the power (low output power indicated by a one-dot chain line in FIG. 5A) when FCS 11 is operated under a condition in which the power generation efficiency of FCS 11 is higher than a predetermined efficiency.

In addition, second power P2 output by battery 21 is set to power in accordance with a difference between the request output and first power P1. As a result, it is possible to offset with the output of battery 21 the difference between the output of FCS 11 (which is suppressed to a low output) and the request output.

In addition, first power P1 in a case where the SOC of battery 21 is lower than a predetermined amount is set to be higher than first power P1 in a case where the SOC is not lower than the predetermined amount. FIG. 5A illustrates first power P1′ set to be high. When the decrease in the SOC of battery 21 progresses, it is necessary to suppress the output of second power P2 in order to prevent the SOC of battery 21 from being depleted. Therefore, by setting first power P1 in a case where the SOC of battery 21 is lower than the predetermined amount to be higher than first power P1 in a case where the SOC is not lower than the predetermined amount, the following becomes possible: to offset, with the output of FCS 11, a difference between second power P2 (which is lower than the power in accordance with the request output) and the request output.

When the Rb is larger than the Rf, control section 100 controls FCS 11 and battery 21 in such a way that battery 21 outputs predetermined third power P3 (W) regardless of the request output and FCS 11 outputs fourth power P4 (W) in accordance with the request output. When the Rb is larger than the Rf, as illustrated in FIG. 5B, battery 21 outputs third power P3, which is predetermined power lower than power in accordance with the request output. Third power P3 of battery 21 may decrease as the SOC of battery 21 decreases. FIG. 5B illustrates third power P3′ that decreases with a decrease in the SOC. On the other hand, FCS 11 outputs fourth power P4, which is a difference between the request output and third power P3. As a result, the deterioration of battery 21 having a larger change rate is suppressed (battery deterioration suppression).

In the battery deterioration suppression, when the decrease in the SOC of battery 21 progresses, there is a concern that a difference between an initial output of FCS 11 and the request output cannot be offset by the output of battery 21. Therefore, when the SOC of battery 21 is reduced, the output of FCS 11 is increased to suppress the output of battery 21, thereby making it possible to prevent the SOC of battery 21 from being depleted. As a result, when battery 21 outputs third power P3 (which is predetermined power lower than power in accordance with the request output) as indicated by a thick solid line in FIG. 5B, fourth power P4 output by FCS 11 becomes power (which is a difference between the request output and third power P3) as indicated by a one-dot chain line in FIG. 5B.

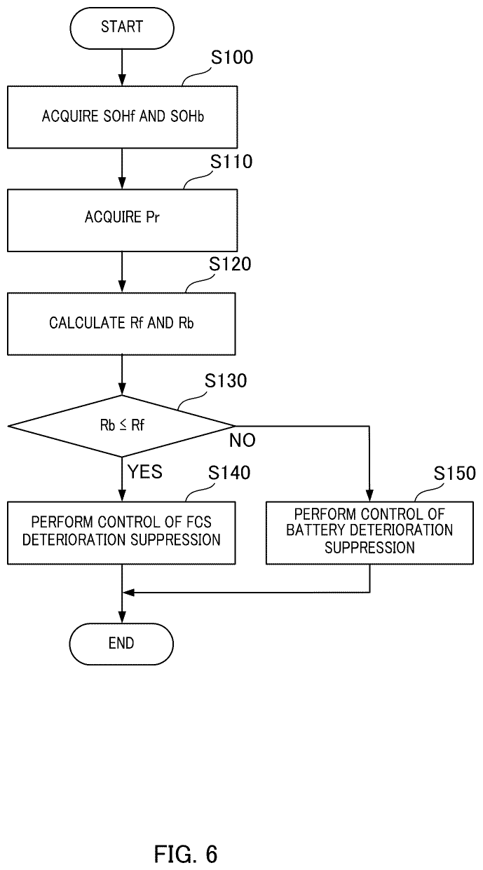

Next, an example of an operation of control section 100 in the embodiment of the present disclosure will be described with reference to FIG. 6. FIG. 6 is a flowchart illustrating an example of an operation of control section 100 according to the embodiment of the present disclosure. The present flow is started by turning on a power switch of the FCV. In addition, the present flow is repeated at a predetermined time interval.

First, in step S100, acquisition section 120 acquires SOHf from fuel cell control section 12. Acquisition section 120 also acquires SOHb from BMS 22.

Next, in step S110, acquisition section 120 acquires output request Pr from motor 31.

Next, in step S120, calculation section 130 calculates Rf. Calculation section 130 also calculates Rb.

Next, in step S130, determination section 140 determines whether Rb is equal to or less than Rf. When Rb is equal to or less than Rf (step S130: YES), the processing proceeds to step S140. When Rb is larger than Rf (step S130: NO), the processing proceeds to step S150.

In step S140, control section 100 controls FCS 11 and battery 21 in such a way that FCS 11 outputs predetermined first power P1 regardless of the request output and battery 21 outputs second power P2 in accordance with the request output (FCS deterioration suppression). Thereafter, the present flow ends.

In step S150, control section 100 controls FCS 11 and battery 21 in such a way that battery 21 outputs predetermined third power P3 regardless of the request output and FCS 11 outputs fourth power P4 in accordance with the request output (battery deterioration suppression). Thereafter, the present flow ends.

The output control device (control system 4) in the above-described embodiment includes acquisition section 120 and control section 100. Acquisition section 120 acquires Rf (change rate) of the SOHf of FCS 11, which outputs power for operating motor 31 serving as a driving source of a vehicle, and Rb (change rate) of the SOHb of battery 21, which outputs power for operating motor 31, and further acquires information indicating a request output from motor 31. Control section 100 controls battery 21 and FCS 11 in such a way that, when Rb is equal to or less than a target value set in advance (herein, Rf), FCS 11 outputs predetermined first power P1 regardless of the request output and battery 21 outputs second power P2 in accordance with the request output, and when Rb is larger than Rf, battery 21 outputs predetermined third power P3 regardless of the request output, and FCS 11 outputs fourth power P4 in accordance with the request output.

With the above configuration, since the degree of deterioration of the SOH of FCS 11 can be easily compared with the degree of reduction of the SOH of battery 21 based on the change rate of the SOH of each of FCS 11 and battery 21, and therefore it is possible to balance the deterioration between FCS 11 and battery 21.

In addition, in control system 4 in the above-described embodiment, Rf, which is the change rate of the SOHf of FCS 11, is used as information relating to the state of health of FCS 11, and Rf is set as the target value. This configuration allows battery 21 and FCS 11 to be controlled based on the determination result of whether Rb is equal to or less than Rf, thereby making it possible to quickly perform the determination. As a result, it becomes possible to quickly control battery 21 and FCS 11.

In addition, in the output control device in the embodiment of the present disclosure, the information relating to the state of health of FCS 11 is Rf of the SOHf of FCS 11. In addition, the information relating to the state of health of battery 21 is Rb of the SOHb of battery 21. Further, with each of FCS 11 and battery 21 serving as a power source, Rf and Rb each are a proportion of the amount of change in the SOH from the start of use of the power source to the current time with respect to the total amount of change in the SOH from the start of use of the power source to the end of use at which the use of the power source reaches an end due to the lifetime of the power source.

In general, there is a difference between the total amount of change in the SOH of FCS 11 and the total amount of change in the SOH of battery 21. Therefore, a difference occurs between the progression speed of the deterioration of FCS 11 and the progression speed of the deterioration of battery 21. As a result, it is difficult to relatively monitor the degrees of reduction of the SOH of respective FCS 11 and battery 21. In the embodiment of the present disclosure, by comparing Rb (change rate) with Rf (change rate), the degrees of reduction of the SOH of respective FCS 11 and battery 21 can be relatively monitored as a result, making it easy to balance the deterioration between FCS 11 and battery 21. (Variation 1)

Next, Variation 1 of the embodiment of the present disclosure will be described.

Control section 100 in the above-described embodiment uses Rf as the target value, compares Rf with Rb, and controls FCS 11 and battery 21 based on the comparison result. Rf is a value that increases according to the cruising distance of the vehicle. However, the target value in the present disclosure is not limited to Rf.

The target value in Variation 1 is a value that is set in advance so as to increase according to the cruising distance (km), similarly to Rf and Rb illustrated in FIG. 3. The relationship between the cruising distance and the target value is set based on a durability test result, a simulation using a deterioration model, or an empirical rule. The target value set in this way may be referred to as a “SOH deterioration model line”. For example, a target value at the start of use of the power source is set to 0 (%), and a target value at the end of use of the power source is set to 100 (%). Storage section 110 has table TBL (see FIG. 4) indicating the relationship between cruising distance (km) and target value (%).

If it is assumed that the target value is set to a fixed value without increasing according to the cruising distance, when the target value is low, change rate Rb of the SOHb of battery 21 would continue to be equal to or greater than the target value, and thus the operation in a control mode of the FCS deterioration control continues, which would accelerate the deterioration on battery 21 side. In addition, when the target value is high, the change rate of each of FCS 11 and battery 21 becomes smaller than a target value before a certain cruising distance is reached, and it is difficult to switch to an appropriate control mode for deterioration suppression. In either case, it is difficult to achieve the object of the present disclosure, namely balancing the deterioration between FCS 11 and battery 21. As described above, by setting the target value in advance so as to increase according to the cruising distance, it is possible to balance the deterioration between FCS 11 and battery 21 along the model line of the SOH deterioration with respect to the cruising distance. In addition, by setting the target value as, for example, a prediction value based on an empirical rule, it is possible to perform control such that both FCS 11 and battery 21 reach their predicted lifetimes.

Calculation section 130 in Variation 1 calculates a target value based on a cruising distance read out from storage section 110 and table TBL. Calculation section 130 calculates Rdf that is a difference between Rf and the target value. In addition, calculation section 130 calculates Rdb that is a difference between Rb and the target value.

Determination section 140 in Variation 1 determines whether Rdb is larger than 0. Determination section 140 also determines whether Rdf is larger than 0. In addition, determination section 140 determines whether Rdb is smaller than Rdf.

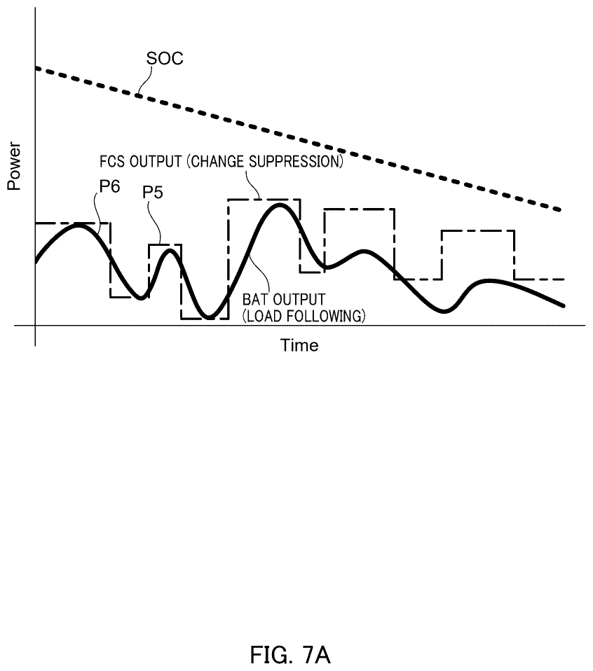

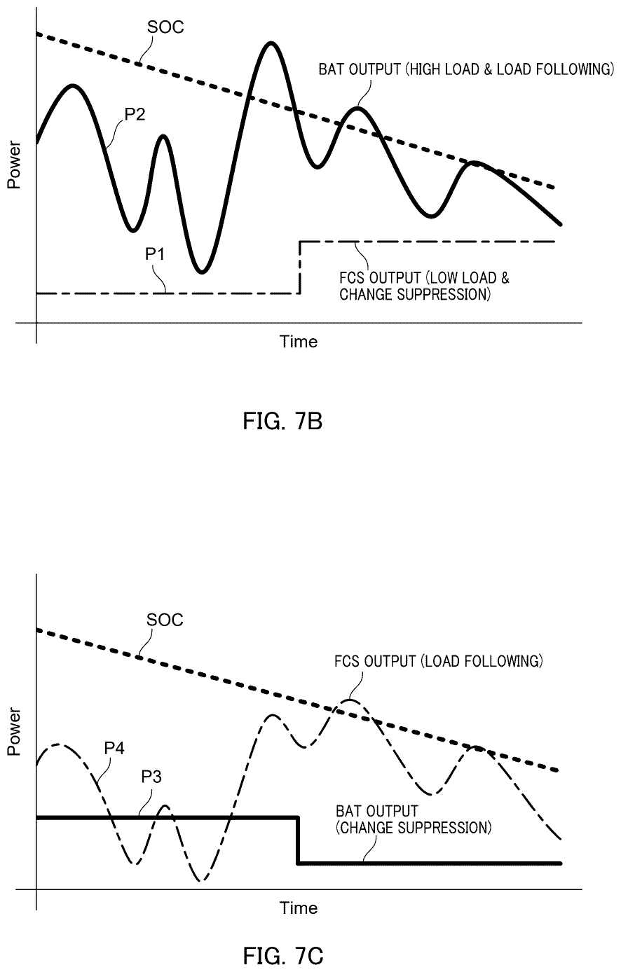

FIG. 7A illustrates an example of a control method for each of an FCS and a battery in Variation 1. FIG. 7B illustrates another example of the control method for each of the FCS and the battery in Variation 1. FIG. 7C illustrates another example of the control method for each of the FCS and the battery in Variation 1. The horizontal axis of each of FIG. 7A, FIG. 7B, and FIG. 7C indicates Time (time), and the vertical axis indicates Power (output). In addition, FIG. 7A, FIG. 7B, and FIG. 7C illustrate an SOC that decreases with the elapse of time.

When Rdf is larger than 0 and Rdb is larger than 0, control section 100 in Variation 1 controls FCS 11 and battery 21 in such a way that FCS 11 outputs fifth power P5 (W) that is half of the request output, and battery 21 outputs sixth power P6 that is a difference between the request output and fifth power P5. In this case, as illustrated in FIG. 7A, the control of FCS 11 becomes constant output control with a rough load changing period. The control of battery 21 becomes load following control. As a result, when both change rates Rf and Rb of FCS 11 and battery 21 exceed the target value, deterioration of neither FCS nor battery 21 is suppressed (no deterioration suppression). Fifth power P5 may increase as the SOC of battery 21 decreases. In other words, fifth power P5 may be set to be higher when the SOC of battery 21 is lower than a predetermined amount than when the SOC is not lower than the predetermined amount.

The above-described control method with no deterioration suppression is a control method to be used when FCS 11 and battery 21 have both deteriorated to an advanced state. When the output of one of the power sources, namely FCS 11 or battery 21, is suppressed and the other power source, namely FCS 11 or battery 21, is actively output, the deterioration of the other power source progresses relative to the one power source, making it difficult to balance the deterioration between FCS 11 and battery 21. Therefore, when FCS 11 and battery 21 have both deteriorated to an advanced state, the control method with no deterioration suppression is adopted.

In addition, in the control method with no deterioration suppression, when the SOC of battery 21 is reduced, the output of battery 21 may be suppressed so that the SOC is not depleted. In this case, sixth power P6 would be reduced. In order to offset a difference between sixth power P6 (which is reduced) and the request output with the output of FCS 11, fifth power P5 may be increased. That is, fifth power P5 may increase as the SOC of battery 21 decreases.

A case has been described where the control method with no deterioration suppression is executed when Rdb is larger than 0 and Rdf is larger than 0, that is, when both Rb and Rf exceed the target value. Next, a control method when Rdb is not larger than 0 or Rdf is not larger than 0, that is, when at least one of Rb and Rf does not exceed the target value will be described.

When at least one of Rb and Rf does not exceed the target value and Rdb is equal to or less than Rdf, control section 100 in Variation 1 controls FCS 11 and battery 21 in such a way that FCS 11 outputs predetermined first power P1 (W) regardless of the request output and battery 21 outputs second power P2 (W) in accordance with the request output. When Rdb is equal to or less than Rdf, as illustrated in FIG. 7B, FCS 11 outputs first power P1, which is predetermined power lower than power in accordance with the request output. First power P1 of FCS 11 may increase as the SOC of battery 21 decreases. On the other hand, battery 21 outputs second power P2, which is a difference between the request output and first power P1. As a result, the respective change rates Rf and Rb of FCS 11 and battery 21 are compared with a target value, and the deterioration of FCS 11 having a smaller margin with respect to the target value of change rates Rf and Rb is suppressed (FCS deterioration suppression).

As described above, in the FCS deterioration suppression in Variation 1, a determination method (control condition) is different from that of the FCS deterioration suppression in the above-described embodiment. The control method may be the same as that of the FCS deterioration suppression in the above-described embodiment.

When Rdb is larger than Rdf, control section 100 in Variation 1 controls FCS 11 and battery 21 in such a way that battery 21 outputs predetermined third power P3 (W) regardless of the request output and FCS 11 outputs fourth power P4 (W) in accordance with the request output. When Rdb is larger than Rdf, as illustrated in FIG. 7C, battery 21 outputs third power P3, which is predetermined power lower than power in accordance with the request output. Third power P3 may decrease as the SOC of battery 21 decreases. On the other hand, FCS 11 outputs fourth power P4, which is a difference between the request output and third power P3. As a result, the deterioration of battery 21 having a smaller margin is suppressed (battery deterioration suppression).

As described above, in the battery deterioration suppression in Variation 1, a determination method (control condition) is different from that of the battery deterioration control in the above-described embodiment. The control method may be the same as that of the battery deterioration suppression in the above-described embodiment.

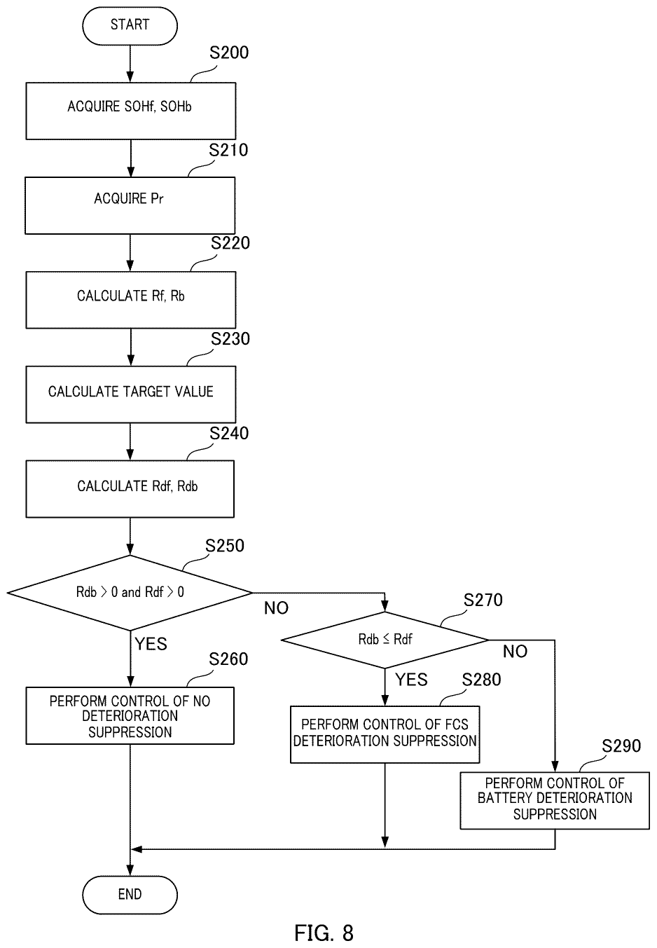

Next, an example of the operation of control section 100 in Variation 1 will be described with reference to FIG. 8. FIG. 8 is a flowchart illustrating an example of the operation of control section 100 in Variation 1. The present flow is started by turning on a power switch of the FCV. In addition, the present flow is repeated at a predetermined time interval.

First, in step S200, acquisition section 120 acquires SOHf from fuel cell control section 12. Acquisition section 120 also acquires SOHb from BMS 22.

Next, in step S210, acquisition section 120 acquires output request Pr from motor 31.

Next, in step S220, calculation section 130 calculates Rf. Calculation section 130 also calculates Rb.

Next, in step S230, calculation section 130 calculates a target value based on the cruising distance and table TBL read out from storage section 110.

Next, in step S240, calculation section 130 calculates Rdf that is a difference between Rf and the target value. Calculation section 130 also calculates Rdb, which is a difference between Rb and the target value.

Next, in step S250, determination section 140 determines whether Rdb is larger than 0 and Rdf is larger than 0. When Rdb is larger than 0 and Rdf is larger than 0 (step S250: YES), the processing proceeds to step S260. When Rdb is not larger than 0 or Rdf is not larger than 0 (step S250: NO), the processing proceeds to step S270.

In step S260, control section 100 controls FCS 11 and battery 21 in such a way that FCS 11 outputs fifth power P5 (W), which is half of the request output, and battery 21 outputs sixth power P6, which is a difference between the request output and fifth power P5 (no deterioration suppression). Thereafter, the present flow ends.

In step S270, determination section 140 determines whether Rdb is smaller than Rdf. When Rdb is equal to or less than Rdf (step S270: YES), the processing proceeds to step S280. When Rdb is not equal to or less than Rdf (step S270: NO), the processing proceeds to step S290.

In step S280, control section 100 controls FCS 11 and battery 21 in such a way that FCS 11 outputs predetermined first power P1 regardless of the request output, and battery 21 outputs second power P2 in accordance with the request output (FCS deterioration suppression). Thereafter, the present flow ends.

In step S290, control section 100 controls FCS 11 and battery 21 in such a way that battery 21 outputs predetermined third power P3 regardless of the request output and FCS 11 outputs fourth power P4 in accordance with the request output (battery deterioration suppression). Thereafter, the present flow ends. (Variation 2)

### Next, Variation 2 Will Be Described.

In Variation 1, the SOH deterioration model line is used as a target value, difference Rdb between Rb and the target value and difference Rdf between Rf and the target value are calculated, Rdb and Rdf are compared with each other, and FCS 11 and battery 21 are controlled based on the comparison result.

In Variation 2, the SOH deterioration model line is used as the target value in the same manner as in Variation 1, and the target value is a value that is set in advance so as to increase according to the cruising distance (km), similarly to Rf and Rb illustrated in FIG. 3. However, in Variation 2, FCS 11 and battery 21 are controlled based on a result of comparing Rb with the target value and a result of comparing Rf with the target value.

As described above, the SOH deterioration model line is used as the target value in Variation 2. Storage section 110 has table TBL (see FIG. 4) indicating the relationship between cruising distance (km) and target value (%).

Calculation section 130 in Variation 2 calculates the target value based on the cruising distance read out from storage section 110 and table TBL (see FIG. 4).

Determination section 140 in Variation 2 determines whether Rb is larger than the target value. In addition, determination section 140 determines whether Rf is larger than the target value.

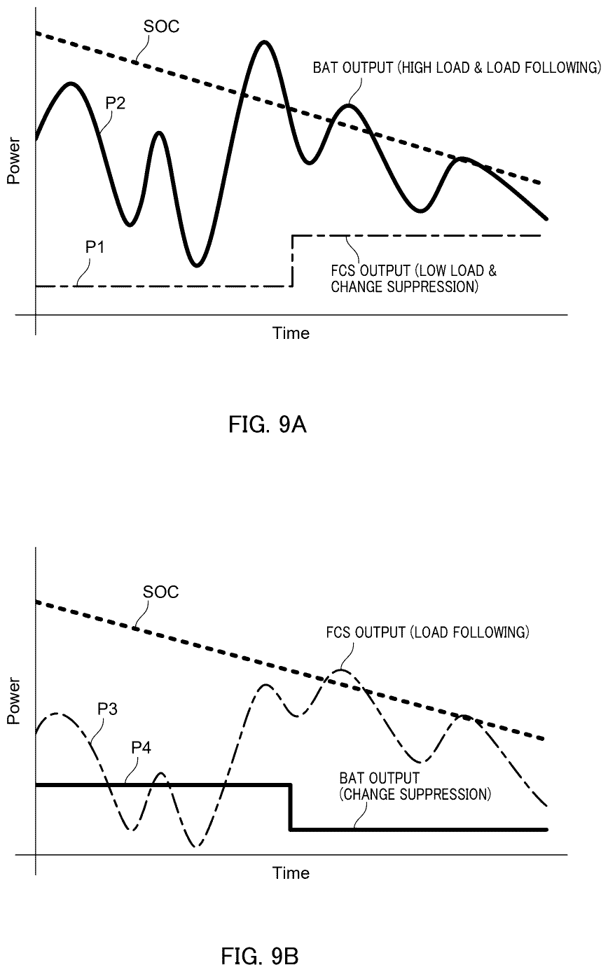

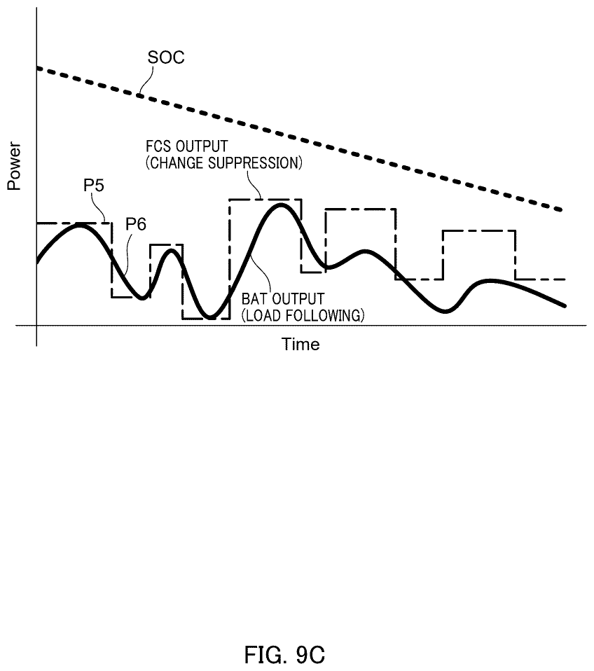

FIG. 9A illustrates an example of a control method for each of an FCS and a battery in Variation 2. FIG. 9B illustrates another example of the control method for each of the FCS and the battery in Variation 2. FIG. 9C illustrates another example of the control method for each of the FCS and the battery in Variation 2. The horizontal axis of each of FIG. 9A, FIG. 9B, and FIG. 9C indicates Time (time), and the vertical axis indicates Power (output). In addition, FIG. 9A, FIG. 9B, and FIG. 9C illustrate an SOC that decreases with the elapse of time.

When Rb is equal to or less than the target value, control section 100 in Variation 2 controls FCS 11 and battery 21 in such a way that FCS 11 outputs predetermined first power P1 (W) regardless of the request output, and battery 21 outputs second power P2 (W) in accordance with the request output. In this case, as illustrated in FIG. 9A, FCS 11 outputs first power P1, which is predetermined power lower than power in accordance with the request output. First power P1 of FCS 11 may increase as the SOC of battery 21 decreases. On the other hand, battery 21 outputs second power P2, which is a difference between the request output and first power P1. As a result, the deterioration of FCS 11 is suppressed (FCS deterioration suppression). In the FCS deterioration suppression in Variation 2, a determination method (control condition) is different from that of the FCS deterioration suppression in Variation 1. The control method may be the same as that of the FCS deterioration suppression in Variation 1.

When Rb is larger than the target value and Rf is equal to or less than the target value, control section 100 in Variation 2 controls FCS 11 and battery 21 in such a way that battery 21 outputs predetermined third power P3 (W) regardless of the request output and FCS 11 outputs fourth power P4 (W) in accordance with the request output. In this case, as illustrated in FIG. 9B, battery 21 outputs third power P3, which is predetermined power lower than power in accordance with the request output. Third power P3 may decrease as the SOC of battery 21 decreases. On the other hand, FCS 11 outputs fourth power P4, which is a difference between the request output and third power P3. As a result, the deterioration of battery 21 is suppressed (battery deterioration suppression). In the battery deterioration suppression in Variation 2, a determination method (control condition) is different from that of the battery deterioration suppression in Variation 1. The control method may be the same as that of the battery deterioration suppression in Variation 1.

When Rb is larger than the target value and Rf is larger than the target value, control section 100 in Variation 2 controls FCS 11 and battery 21 in such a way that FCS 11 outputs fifth power P5, which is half of the request output, and battery 21 outputs sixth power P6, which is in accordance with a difference between the request output and fifth power P5. In this case, as illustrated in FIG. 9C, the control of FCS 11 becomes constant output control with a rough load changing period. Fifth power P5 may increase as the SOC of battery 21 decreases. The control of battery 21 becomes load following control. As a result, the deterioration of neither FCS nor battery 21 is suppressed (no deterioration suppression). In the no deterioration suppression in Variation 2, a determination method (control condition) is different from that of the no deterioration suppression in Variation 1. The control method may be the same as that of the no deterioration suppression in Variation 1.

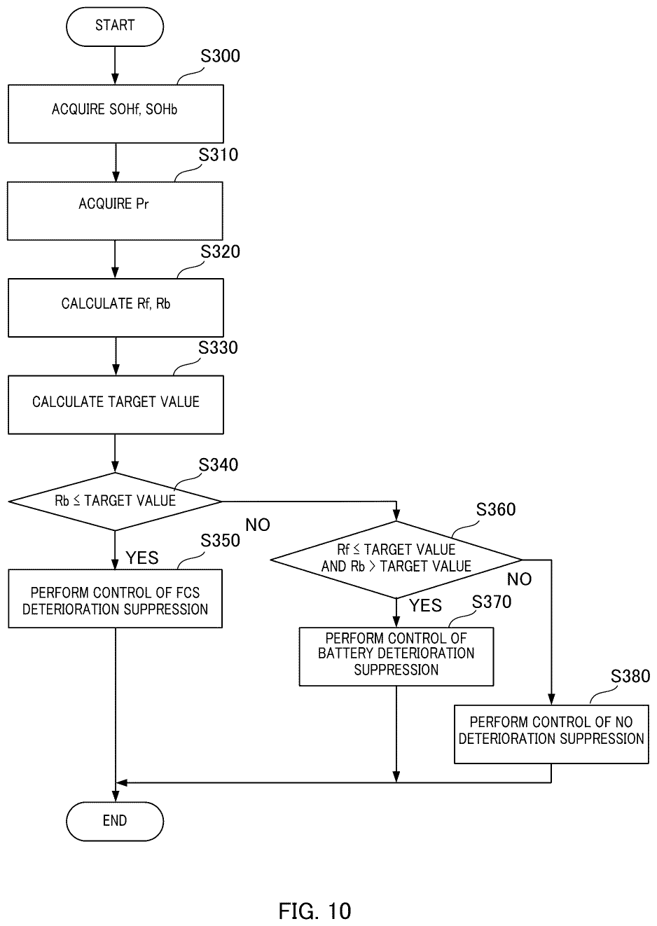

Next, an example of the operation of control section 100 in Variation 2 will be described with reference to FIG. 10. FIG. 10 is a flowchart illustrating an example of the operation of control section 100 in Variation 2. The present flow is started by turning on a power switch of the FCV. In addition, the present flow is repeated at a predetermined time interval.

First, in step S300, acquisition section 120 acquires SOHf from fuel cell control section 12. Acquisition section 120 also acquires SOHb from BMS 22.

Next, in step S310, acquisition section 120 acquires output request Pr from motor 31.

Next, in step S320, calculation section 130 calculates Rf. Calculation section 130 also calculates Rb.

Next, in step S330, calculation section 130 calculates a target value based on the cruising distance and table TBL read out from storage section 110.

Next, in step S340, determination section 140 determines whether Rb is equal to or less than the target value. When Rb is equal to or less than the target value (step S340: YES), the processing proceeds to step S350. When Rb is larger than the target value (step S340:
NO), the processing proceeds to step S360.

Next, in step S350, control section 100 controls FCS 11 and battery 21 in such a way that FCS 11 outputs predetermined first power P1 regardless of the request output, and battery 21 outputs second power P2 in accordance with the request output (FCS deterioration suppression).

Next, in step S360, determination section 140 determines whether Rf is equal to or less than the target value. When Rf is equal to or less than the target value (step S360: YES), the processing proceeds to step S370. When Rf is not equal to or less than the target value (step S360: NO), the processing proceeds to step S380.

Next, in step S370, control section 100 controls FCS 11 and battery 21 in such a way that battery 21 outputs predetermined third power P3 regardless of the request output, and FCS 11 outputs fourth power P4 in accordance with the request output (battery deterioration suppression).

Next, in step S380, control section 100 controls FCS 11 and battery 21 in such a way that FCS 11 outputs fifth power P5 (W), which is half of the request output, and battery 21 outputs sixth power P6, which is a difference between the request output and fifth power P5.

In control system 4 (output control device) in the above-described embodiment, the target value is set to Rf (the change rate of the SOH of FCS 11), whether Rf is equal to or larger than Rb is determined, and the output of FCS 11 and the output of battery 21 are controlled based on the determination result. In addition, in Variations 1 and 2, the target value is set to a value (a value based on the SOH deterioration model) that increases according to the cruising distance, and the output of FCS 11 and the output of battery 21 are controlled based on Rf, Rb, and the target value.

However, the target value in the present disclosure may be Rb. In this case, the following configuration is possible: whether Rf is equal to or less than Rb is determined, and the output of each of FCS 11 and battery 21 is controlled based on the determination result.

In Variation 2, one value based on a SOH deterioration model is used as the target value, but the target value in the present disclosure is not limited to one value. In particular, as the control condition (determination method) of no deterioration suppression, for example, two or more target values different from each other, such as a first target value to be compared with Rb and a second target value to be compared with Rf, may be provided. In addition, for example, two or more models selected by a user from among a plurality of SOH deterioration models that are set according to a usage aspect of the FCV may be used as the target value.

Each of the above-described embodiment merely shows an example of specific implementation of the present disclosure, and the technical scope of the present disclosure should not be construed to be limited thereto. That is, the present disclosure can be implemented in a variety of ways without departing from the spirit or essential features thereof.

### INDUSTRIAL APPLICABILITY

The present disclosure is suitably used for an FCV including an output control device that is required to balance deterioration between a battery and a fuel cell.

1. An output control device comprising:
an acquisition section that acquires information relating to a state of health of a fuel cell, information relating to a state of health of a battery, and information indicating a request output from a motor serving as a driving source of a vehicle, the fuel cell being configured to output power for operating the motor, the battery being configured to output power for operating the motor; and
a control section that controls the battery and the fuel cell in such a way that, when the information relating to the state of health of the battery is equal to or less than a target value set in advance, the fuel cell outputs predetermined first power regardless of the request output and the battery outputs second power in accordance with the request output, and when the information relating to the state of health of the battery is larger than the target value, the battery outputs predetermined third power regardless of the request output and the fuel cell outputs fourth power in accordance with the request output.

2. The output control device according to claim 1, wherein the target value is the information relating to the state of health of the fuel cell.

3. The output control device according to claim 1, wherein
the target value is a value set in advance so as to increase according to a cruising distance of the vehicle.

4. The output control device according to claim 1, wherein
the first power is power when the fuel cell is operated under a condition in which power generation efficiency of the fuel cell is higher than predetermined efficiency.

5. The output control device according to claim 1, wherein
the first power in a case where a remaining capacity of the battery is lower than a predetermined amount is higher than the first power in a case where the remaining capacity is not lower than the predetermined amount.

6. The output control device according to claim 1, wherein
the second power is power in accordance with a difference between the request output and the first power.

7. The output control device according to claim 1, wherein
the third power in a case where a remaining capacity of the battery is lower than a predetermined amount is lower than the third power in a case where the remaining capacity is not lower than the predetermined amount.

8. The output control device according to claim 1, wherein
the fourth power is power in accordance with a difference between the request output and the third power.

9. The output control device according to claim 1, wherein
the control section controls the battery and the fuel cell in such a way such that, when the information relating to the state of health of the battery exceeds a first target value determined in advance and the information relating to the state of health of the fuel cell exceeds a second target value determined in advance, the fuel cell outputs fifth power in accordance with the request output and the battery outputs sixth power in accordance with a difference between the request output and the fifth power.

10. The output control device according to claim 9, wherein
the fifth power in a case where a remaining capacity of the battery is lower than a predetermined amount is higher than the fifth power in a case where the remaining capacity is not lower than the predetermined amount.

11. An output control device comprising:
an acquisition section that acquires information relating to a state of health of a fuel cell, information relating to a state of health of a battery, and information indicating a request output from a motor serving as a driving source of a vehicle, the fuel cell being configured to output power for operating the motor, the battery being configured to output power for operating the motor; and
a control section that controls power output from the battery and power output from the fuel cell based on the information relating to the state of health of the fuel cell, the information relating to the state of health of the battery, and the request output.

12. The output control device according to claim 1, wherein:
the information relating to the state of health of the fuel cell is a change rate of the state of health of the fuel cell serving as a power source;
the information relating to the state of health of the battery is a change rate of the state of health of the battery serving as the power source; and
each of the change rate of the state of health of the fuel cell and the change rate of the state of health of the battery is a proportion of an amount of change in the state of health from a start of use of the power source to a current time with respect to a total amount of change in the state of health from the start of use to an end of use at which the use of the power source reaches an end due to a lifetime of the power source.
